(19) United States
(12) Patent Application Publication
(10) Pub. No.: US 2003/0016671 A1
(43) Pub. Date: Jan. 23, 2003

(54) Wavelength division multiplexed network with frame switching

(76) Inventor: Richard S. Johnston, Sammamish, WA (US)

Correspondence Address: ALL OPTICAL NETWORKS, INC., 9440 CARROLL PARK DRIVE, SAN DIEGO, CA, 92121, US

(21) Appl. No.: 10/155,448

(22) Filed: May 23, 2002

Related U.S. Application Data
(60) Provisional application No. 60/292,875, filed on May 23, 2001.

(51) Int. Cl. H04L 12/56; H04J 3/04

(52) U.S. Cl. 370/392; 370/536

(57) ABSTRACT

A network architecture for wavelength division multiplexed (WDM) networks that allows frame switching without converting the data frames to electronic form. The WDM network consists of some number (N) of wavelength channels. The architecture separates the channels into one (or more if needed) control channel and N−1 data channels. Only the control channel undergoes electrical conversion at a switching node of the network. The control channel contains all the information needed to control routing of the data channels without converting the data channels to electrical form.

### RELATED APPLICATION

This Application claims the benefit of priority to U.S. Provisional Patent Application Serial No. 60/292,875, filed May 23, 2001, currently co-pending and fully incorporated herein by this reference.

### PROBLEM & BACKGROUND

WDM is being used in fiber optic communications networks to allow a single fiber to carry multiple channels of data. In today's WDM networks each wavelength channel may contain data of a different encoding format. In addition, each channel may be destined for a different final location. At periodic switching nodes where multiple WDM fibers meet the wavelength channels on each fiber are separated (demultiplexed). Some channels are dropped for distribution within a local network and some channels that originate locally are added. All channels are then switched and multiplexed onto outgoing fibers. The switching is under control of network configuration software. Two types of switches are currently in use of being developed, these being optical-electrical-optical (OEO) switches (sometimes called opaque switches) and all optical transparent switches.

OEO switches are available today. These switches take the data from each wavelength channel and convert it to electrical form. The switching is performed in electronics. Each output channel is then regenerated into an optical signal and sent out. These switches have great flexibility including the ability to change the wavelength of a channel. Unfortunately OEO systems have several drawbacks as listed below:

The systems are expensive as the optical to electrical and electrical to optical components are expensive.

The systems are large and use tremendous amounts of power.

The systems accept data in a particular format with a specific bit rate. If one wants to send higher data rates down the wavelength channels it will involve replacing the switch.

All optical transparent switches are being developed. These switches keep the data in optical form while performing the switching operation. By avoiding the OEO conversions these switches promise to be smaller and cheaper than OEO switches and will allow any data format to be switched. One such switch in development uses large numbers of small moving mirrors to redirect the channels (free space optical switching). The primary drawbacks of this type of switch are the switching speed (mechanical motion of the mirrors) and the fact that the switch has no knowledge of the data. Other switching methods under development (such as waveguide switching) hold the potential to switching times but still leave the switch with no knowledge of the data.

Why is knowledge of the data important? In a circuit switched network where a central software system is making all network configuration decisions it is only important as a monitor of data integrity. Advanced networks, especially those that transport Internet frames, need to dynamically route the data on a frame (or packet) by frame basis These networks are called packet switched networks (an Internet packet can be though of as a small variable length frame). Each frame contains data and a header. The header contains information that tells the switching system (in this case a router) where the frame is headed. The router uses this information to determine how to forward the frame. Frame switch networks are in a mesh configuration. That is, each switching node is connected to multiple other switching nodes. Nodes and connections can be added as desired. The network reconfigures itself such that optimal routing is achieved.

Frame switched networks require three major features that transparent switches being developed do not provide for. These are:

Ability to view and process the data headers in electronic form such that routing decisions can be made. At the present time optical computers do not have the capability to process routing algorithms in a cost-effective fashion.

Ability to store data in an optical form. In a frame switched network multiple frames may need to be routed to the same location at the same time. In an electronic router the frame and data are placed in a memory queue until the communication channel is available.

Ability to switch at frame rates. There are switches in development that promise fast switching times but moving mirror switches are to slow to accommodate frame switching as it is currently performed.

It is the goal of this invention to allow a mesh configured network to switch frames without converting the data to electronic form.

### INVENTION DESCRIPTION

Consider a WDM network with N wavelengths. In this system one wavelength will be reserved for header or routing (hereafter referred to as the header) information and the remaining N−1 wavelengths reserved for data (note that in the case all header and routing information can not be contained in a single wavelength additional wavelength can be used). The switch (or router in this case) will perform an optical to electrical conversion only on the wavelength designated for the header information. All other wavelengths will be switched without conversion to electronic form.

In the preferred embodiment of the invention data frames on each wavelength are synchronous across the entire network. That is, each information frame starts and ends at the same time (if some frames are shorter the remaining space can be left blank). The data frames have a fixed transport time (called the frame time) but the data within the frame can be of any format and speed desired.

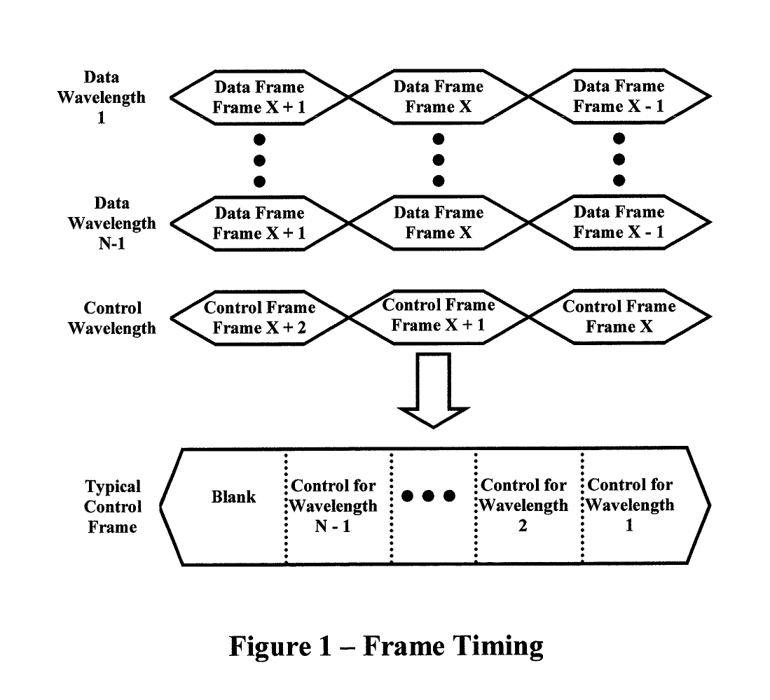

In the preferred embodiment the wavelength channel containing headers, called the control channel, will have a fixed format. A control frame will contain the information needed to route each data wavelength. This information will be contained in subframes, one for each wavelength. An important feature of the invention is that the control frame will occur one time period (or frame) before the data frames it is to control (they could occur multiple time periods before but this has little usefulness if the electronics can process at a high speed). In this way the electronic computer will have time to make decisions before the data arrives. In most cases it is desirable for all control subframes to be available well before the end of the frame period such that the electronics have time to complete there routing calculations. See FIG. 1 for a timing diagram of the WDM data.

With the routing information being available before the data it is to control the system can be ready to set up the switch at the beginning of the next frame time. Remember that this switch is quite large. Its number of ports is typically equal to the number of wavelengths per fiber times the total number of fibers into the network node. If the switching time for the optical data is fast (sub microsecond) as is the case with some switches under development the system simply performs the switching between frames. If however the switching time is long (a large percentage of the frame time) one does not want to wait for the switch as this will reduce throughput of the entire network. In this case two (or more) parallel switching matrices can be used. One can be set up while the other is passing data. On the frame boundary one only has to switch between the two switches, a much faster operation.

Making the entire network synchronous can be a difficult task. The key issue is the variable transport time between network nodes. On solution is to allow sufficient dead time between frames such that any variation occurs within this excess time. This will lower the total throughput of the network by an amount equal to the dead time between frames divided by the total transport time of a frame. For this reason larger frame lengths are desirable.

One additional issue is the lack of storage for data in optical form. This can be needed when more that one data frame wants to be sent on the same fiber and at the same wavelength. In this event one of two solutions is available. First the switch can route the data to a port where it is converted to electrical form for storage and then convert it back to optical form when the desired channel is available. The second is configure the network such that the total number of input channels is equal to the total number of output channels. Then the data can be output to some destination even if it is back where it came from. The receiving router will then redirect it to the proper destination.

The control channel can also carry additional information relating to network configuration. This information is typically passed between network nodes when a node or fiber between nodes is added or deleted such that the network can reconfigure itself for optimal performance.

A modification of the invention can be used for circuit switched networks. Here one wavelength still contains control information while the other wavelengths contain data of any format. This data is not necessarily broken into frames as described above. Control information is sent down the control channel whenever the network desires to change configuration. The wavelengths being reconfigured would not pass data while the switching takes place. Once the switching is completed throughout the network the control channel would inform all nodes such that information flow can continue.

In addition to control information the control channel can transport additional information such as network status in either a frame switched or circuit switched network.

As technology advances and optical computing becomes available the OEO conversions and electronic processing on the control channel can be replaced by an optical computer. Here the advantage of a single optical computer over one per wavelength still exists. As storage of information in optical form becomes available the network can be configured to queue frames as required. When this occurs the development of full Internet protocol packet switching networks can occur.

Unique Aspects of the Invention

A WDM network in which one wavelength, the control channel contains the information needed to route the data on the other wavelengths.

A WDM network in which each wavelength contains frames of a specific time period. The data within the frame can be of any desired speed and format.

A WDM network in which frames are synchronous. That is the frames all start at the same time.

A WDM network in which a control channel frame contains information to control data frames that occur one or more frame times in the future.

A WDM network that handles collisions (more than one frame desiring to go down the same channel) by forwarding the frame to some other location (preferably the second best route) instead of placing it into a queue.

A WDM network in which the control channel also contains network configuration data to allow the network nodes to reconfigure the network as nodes and fibers are added or deleted.

A WDM circuit switched network in which one wavelength is used as the control channel. This channel carrying information which causes the network configuration to be altered.

Description of a Router

Scope

The following is an initial description and discussion of the router design being developed by All Optical Networks, Inc. It is meant as a starting point for further discussion and as such, all points are very preliminary and subject to change.

Description

An overriding assumption is that the system being developed and scheduled for prototyping during December of 2001 is a proof of concept prototype and not a product. It may not meet all specifications that a product would be required to meet (back reflection, transmission distance, etc.). It may also be a subset of the final product. For example, the final product may need to support 40 different WDM channels while the prototype may only support 1. It should however, be sufficient to address the majority of issues related to a router product and demonstrate that said issues have been solved.

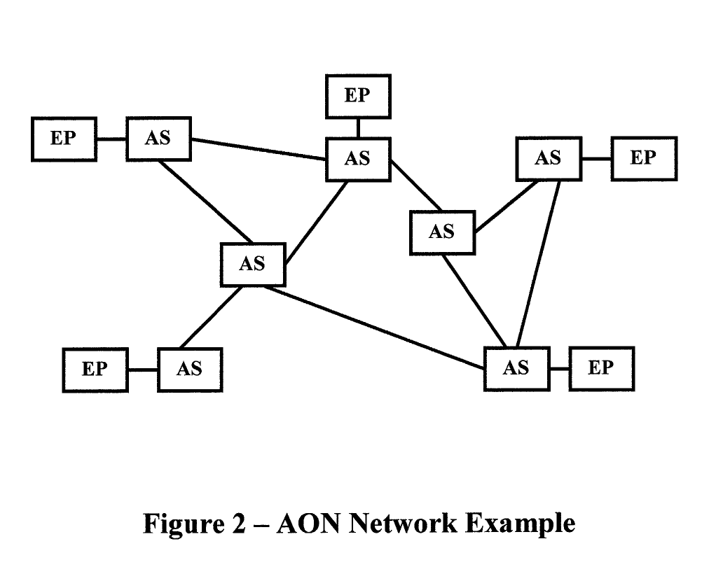

The router will exist at the core of the network and transport Internet protocol (IP) packets. Within the core of the network (called the AON network) all equipment and protocols are controlled by AON. The optical fiber used within the core of the network must be standard fiber that currently exists and not a special fiber type (such as polarization preserving fiber). Within the AON network reside two basic devices as described below and shown in FIG. 2.

Edge Processor (EP)—

EP exists at every node in which data packets enter or leave the AON network. The function of the EP is to receive IP packets in electrical form. The EP will bundle these into larger frames (where individual packets within a frame all exit the AON network at a common node) for transmission through the AON network. The protocol used to bundle the packets is TBD. The EP will convert the electrical signals in a frame into optical form at the desired wavelength and pass them to an AON network switch. Data that is received by an EP from the network is converted to electrical form and the frames broken into IP packets for transmission through the local or metro IP network.

It has been proposed that frames be passed from the metro area network to the ER using Border Gateway Protocol (BGP). As I understand BGR it is a method of passing routing update information and not data. It as also been proposed that EPs communicate with each other via standard Internet connections. EPs would send information on network topology and traffic levels. The EPs would then determine the route a frame takes through the AON network and place this information in the frame header.

AON Switch (AS)—

A switch is a device that exists in the core of the AON network. All data input to an AS comes from an EP or another AS. All data sent by a AS goes to an EP or another AS. The AS is to take data from input fiber(s) and route it to the appropriate output fiber on a frame by frame basis without converting the data to electrical form. It has been proposed that the routing information be contained in the first bits of the header. An AS uses the first bit(s) to determine the switching within that AS then strips these bit(s) before passing the frame on. A number of issues need to be determined for the AS including the following.

What is the optical input to the AS?

Number of fibers.

Number of wavelengths per fiber.

What wavelengths.

Rate of the data on the line (2.5 GBPS, 10 GBPS, etc.).

Coding of the data (return to zero, etc.).

As WDM is being implemented in most networks to make maximum use of the fibers available bandwidth the AON system must be architected to work with multiple wavelengths. For the prototype only one data wavelength needs to be demonstrated as each wavelength can be considered as a separate channel (it is assumed that there will not be wavelength conversion in the device without considerable research). Building only one data wavelength simplifies the multiplexing and demultiplexing functions that would need to be performed with a true DWDM system. While the basic switch should be transparent to the rate and coding method the EP will need to know this as will the AS when it senses the address control bits.

What is the optical output from the AS?

Number of fibers.

Number of wavelengths per fiber.

These will most likely be identical to the input in number and wavelengths. I believe that the AS with only one input data stream and multiple output (the simplest system to build) does not lead to a commercially viable product. This is because it makes very inefficient use of the available bandwidth. With one input path and four output paths the output fibers are only one quarter full.

How does the system minimize collisions as an EP does not know how other EPs are routing data at any given point in time? This is especially important, as there is no buffering within an AS (without converting data to electrical form or significant research into optical buffering). Without buffering how do we handle collisions (assumes there is more than one input stream to the AS)?

How do we know when a header (or the correct routing bits) is present without electrical conversion? What are we using as the timing marks? This will most likely require some type of optical to electronic conversion. If the routing data is contained along with the data to be routed electrical conversion will need to occur on each wavelength channel.

What frame length are we using? Is it fixed or variable? If variable, where is the length information contained? Is there dead time between frames to allow for the switching?

Proposed Architecture—

The architecture I propose for the AON router uses the technology described in the invention disclosure “Wavelength division multiplexed network with frame switching”

a copy of which is attached. The basic concept of this architecture is to use one wavelength of the DWDM fiber to carry switching information while the remaining wavelengths carry data. With this architecture one channel from each fiber undergoes an optical to electronic conversion within the AS. The switching information proceeds in time the data to be switched (the network can be synchronized or a time stamp can tell the AS when to switch). It should also be possible to carry the network configuration tables on the timing wavelength. This would eliminate carrying the configuration information through a separate network.

This architecture will yield an EP and AS that should be simpler than one in which all wavelengths undergo electronic conversion. In addition, the core switching element does not need to be high speed right away. The network can be fully tested with a slower core switch and upgraded as switching speed improves. Slower switching speed simply increases the dead time while switching occurs which reduces the total bandwidth on the fiber by a small percentage.

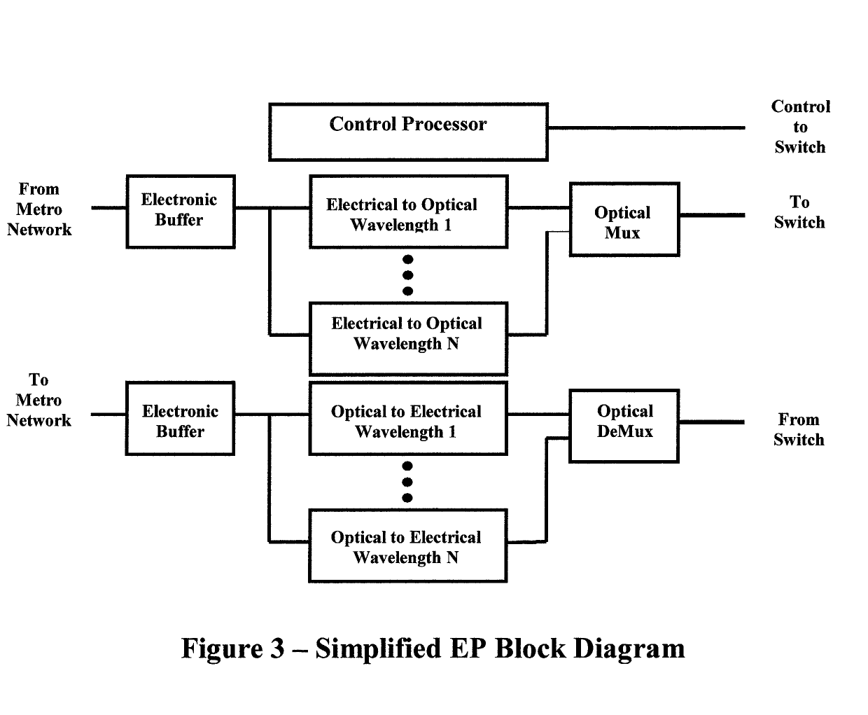

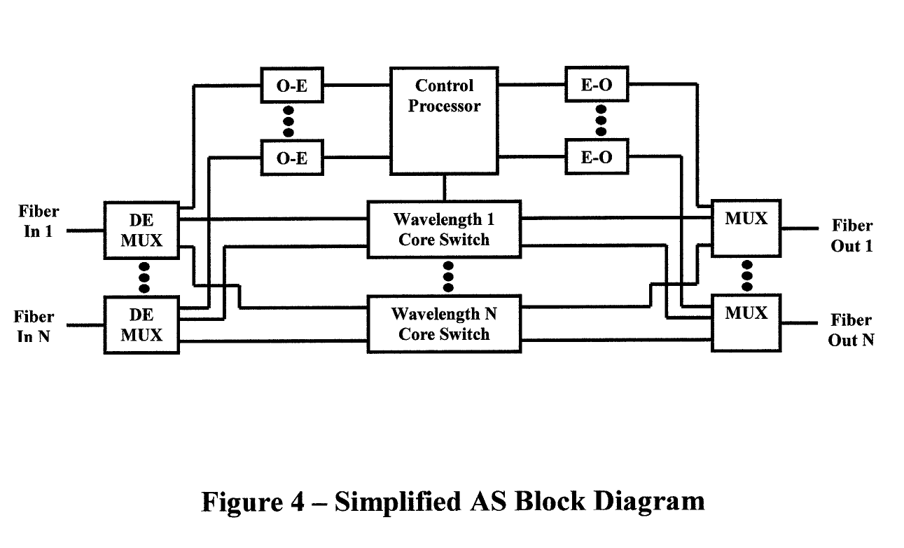

Simplified block diagrams of the EP and the AS designed to work with this architecture are shown in FIGS. 2 and 3. These block diagrams are preliminary and only meant to give an overview of the devices.

1. A wavelength division multiplexed network with frame switching, comprising:
a router for receiving a plurality of optical data channels, wherein one of said optical data channels contains channel routing information;
a demultiplexer for decoding said optical data channel having said channel routing information; and
a means for directing the remaining optical data channels of said plurality of data channels through an optical data network.
